(19) United States
(12) Patent Application Publication
(10) Pub. No.: US 2019/0043330 A1
(43) Pub. Date: Feb. 7, 2019

(54) SYSTEMS AND METHODS FOR CHECKING WEARABLE DEVICE IS CORRECTLY SEATED

(71) Applicant: iBeat, Inc., San Francisco, CA (US)

(72) Inventors: Steven Szabados, Sausalito, CA (US); Behrooze Sirang, San Francisco, CA (US); Sarah Wohlman, Redwood City, CA (US); Brian Boarini, San Francisco, CA (US); Chris Bumgardner, San Francisco, CA (US)

(21) Appl. No.: 16/025,902

(22) Filed: Jul. 2, 2018

Related U.S. Application Data
(63) Continuation-in-part of application No. 15/981,144, filed on May 16, 2018.
Application No. 15/981,144 is a continuation-in-part of application No. 15/967,956, filed on May 1, 2018.
(60) Provisional application No. 62/541,029, filed on Aug. 3, 2017.

(51) Int. Cl. G08B 21/04; G06F 1/16

(52) U.S. Cl. CPC G08B 21/0446; G06F 1/163

(57) ABSTRACT

In various embodiments, a personal emergency detection, notification, coordination and response method and system for individuals is disclosed. A monitoring device, for example a digital smart watch, is configured to identify an emergency using built-in sensors. The sensors are operable to perform spectral analysis of skin tissues. Example sensors include: LEDs and optical detectors for heart rate monitoring, blood perfusion checking, and tissue oxygenation checking; acceleration sensing to sense falls and accidents; and a GPS system for reporting the location of the wearer to interested parties. A communication chip with an associated antenna, and an audio chip are also included. Deviations in vital signs are used to detect health anomalies. By aggregating data that is anonymously collected from multiple users, the system constructs models that are compared with data from a specific user, to warn the user before an emergency occurs, for certain classes of health incidents.

### CROSS-REFERENCE TO RELATED APPLICATIONS

This application is a continuation-in-part of U.S. patent application Ser. No. 15/981,144 filed May 16, 2018, entitled “Systems and Methods for Personal Emergency,” by Ryan HOWARD et al., which claims the benefit of U.S. Provisional Patent Application No. 62/541,029 filed Aug. 3, 2017, entitled “A Personal Emergency System for Emergency Identification, Emergency Notification, and Emergency Response for an Individual,” by Ryan HOWARD et al., which are hereby incorporated by reference.

This application is a continuation-in-part of U.S. patent application Ser. No. 15/967,956 filed May 1, 2018, entitled “Skin Tissue Sensor Device,” by Steven Szabados, which claims the benefit of U.S. Provisional Patent Application No. 62/583,312 filed Nov. 8, 2017, entitled “Dermal and Cardiovascular Spectroscopic Sensor,” by Steven Szabados, which are hereby incorporated by reference.

### BACKGROUND

Health monitoring devices have become available in a wearable format, such as worn on a user's wrist. Many of them have the capability to monitor heart rate but are limited with respect to system intelligence. There is a need in the art for improved devices as well as improved methods for interfacing with them, to enable more sophisticated analysis of vital signs, more effective engagement of available resources, and overall more timely assistance to users undergoing health emergencies. There is a further need for a system architecture that can aggregate data from multiple users anonymously, perform analysis on the data collected, compare user data with behavioral models or standards determined from the analysis, and predict a health emergency before it would otherwise occur.

### SUMMARY

Various embodiments in accordance with the present disclosure can relate to the field of wearable health sensors, and more particularly to intelligent systems comprising wearable health sensors.

In various embodiments, a wearable device includes a processor, a memory containing instructions to be executed by the processor, and a plurality of sensors. In addition, the processor is operable to utilize measurements from the plurality of sensors to check seating status of the wearable device on skin of a wearer of the wearable device.

In various embodiments, the plurality of sensors of the previous paragraph includes a capacitive pad. In various embodiments, the plurality of sensors of the previous paragraph includes a conductive element. In various embodiments, the plurality of sensors of the previous paragraph includes an optical sensor. In various embodiments, the wearable device of the previous paragraph is operable to inform the wearer that the seating status is incorrect includes using at least one of: display a message, produce an audible message, produce an audible alarm, produce a vibration, and display a picture. In various embodiments, the wearable device of the previous paragraph is operable to maintain a history of seating status of the wearable device and allows review of the history. In various embodiments, the wearable device of the previous paragraph is operable to adjust its bio-metric data processing based on the seating status. In various embodiments, the wearable device of the previous paragraph is operable to turn off bio-metric sensing based on the seating status.

In various embodiments, a method for detecting seating of a wearable device, the method includes reading measurements from a plurality of sensors with a processor of the wearable device. Furthermore, the method includes analyzing the measurements with the processor to check seating status of the wearable device on skin of a wearer of the wearable device.

In various embodiments, the plurality of sensors of the previous paragraph includes a capacitive pad. In various embodiments, the plurality of sensors of the previous paragraph includes a conductive element. In various embodiments, the plurality of sensors of the previous paragraph includes an optical sensor. In various embodiments, the method of the previous paragraph further includes informing the wearer that the seating status is incorrect includes the wearable device performing at least one of: displaying a message, producing an audible message, producing an audible alarm, producing a vibration, and displaying a picture. In various embodiments, the method of the previous paragraph further includes maintaining a history of seating status with the processor. In various embodiments, the method of the previous paragraph further includes adjusting bio-metric data processing based on the seating status with the processor.

In various embodiments, a wearable device includes a processor, a memory containing instructions to be executed by the processor, a plurality of capacitive pad sensors, a plurality of conductive sensors, and a plurality of optical sensors. Moreover, the processor is operable to utilize measurements from the plurality of capacitive pad sensors, the plurality of conductive sensors, and the plurality of optical sensors to check seating status of the wearable device on skin of a wearer of the wearable device.

In various embodiments, the wearable device of the previous paragraph is operable to inform the wearer that the seating status is incorrect includes at least one of: display a message, produce an audible message, produce an audible alarm, produce a vibration, and display a picture. In various embodiments, the wearable device of the previous paragraph is operable to maintain a history of seating status of the wearable device and allows review of the history. In various embodiments, the wearable device of the previous paragraph is operable to adjust its bio-metric data processing based on the seating status. In various embodiments, the wearable device of the previous paragraph is operable to turn off bio-metric sensing based on the seating status.

While various embodiments in accordance with the present disclosure have been specifically described within this Summary, it is noted that the claimed subject matter are not limited in any way by these various embodiments.

### BRIEF DESCRIPTION OF THE DRAWINGS

Within the accompanying drawings, various embodiments in accordance with the present disclosure are illustrated by way of example and not by way of limitation. It is noted that like reference numerals denote similar elements throughout the drawings.

FIG. 1 shows a cross-sectional view of a wrist worn health monitoring device in accordance with various embodiments of the present disclosure.

FIG. 2 is a flow diagram that illustrates an exemplary computer implemented method for providing timely emergency assistance to a user whose vital signs have deviated from the normal range in accordance with various embodiments of the present disclosure.

FIG. 3 shows example skin-sensor configurations in accordance with various embodiments of the present disclosure.

FIG. 4 shows an example capacitive-pad-sensor circuit implementation in accordance with various embodiments of the present disclosure.

FIG. 5 shows a voltage-over-time graph for a capacitive pad in accordance with various embodiments of the present disclosure.

FIG. 6 shows an example metal-contact-sensor circuit implementation in accordance with various embodiments of the present disclosure.

FIG. 7 shows an exemplary asymmetric skin-sensing wearable device in accordance with various embodiments of the present disclosure.

FIG. 8 shows an exemplary symmetric skin-sensing wearable device in accordance with various embodiments of the present disclosure.

FIG. 9 shows an exemplary flowchart for detecting and reacting to the skin-sensing measurements in accordance with various embodiments of the present disclosure.

FIG. 10 is a block diagram of an example of a computing system upon which one or more various embodiments described herein may be implemented in accordance with various embodiments of the present disclosure.

### DETAILED DESCRIPTION

Reference will now be made in detail to various embodiments in accordance with the present disclosure, examples of which are illustrated in the accompanying drawings. While described in conjunction with various embodiments, it will be understood that these various embodiments are not intended to limit the present disclosure. On the contrary, the present disclosure is intended to cover alternatives, modifications and equivalents, which may be included within the scope of the present disclosure as construed according to the Claims. Furthermore, in the following detailed description of various embodiments in accordance with the present disclosure, numerous specific details are set forth in order to provide a thorough understanding of the present disclosure. However, it will be evident to one of ordinary skill in the art that the present disclosure may be practiced without these specific details or with equivalents thereof. In other instances, well known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “reading,” “analyzing,” “informing,” “maintaining,” “adjusting,” “implementing,” “inputting,” “operating,” “detecting,” “notifying,” “aggregating,” “applying,” “comparing,” “engaging,” “predicting,” “recording,” “determining,” “identifying,” “generating,” “extracting,” “receiving,” “processing,” “acquiring,” “performing,” “producing,” “providing,” “prioritizing,” “arranging,” “matching,” “measuring,” “storing,” “signaling,” “proposing,” “altering,” “creating,” “computing,” “loading,” “inferring,” or the like, refer to actions and processes of a computing system or similar electronic computing device or processor. The computing system or similar electronic computing device manipulates and transforms data represented as physical (electronic) quantities within the computing system memories, registers or other such information storage, transmission or display devices.

Various embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

In various embodiments, a personal emergency detection, notification, coordination and response method and system for individuals is disclosed. A monitoring device, for example a digital smart watch, is configured to identify an emergency using built-in sensors. The sensors are operable to perform spectral analysis of skin tissues. Example sensors include, but are not limited to: LEDs (light emitting diodes) and optical detectors for heart rate monitoring, blood perfusion checking, and tissue oxygenation checking; acceleration sensing to sense falls and accidents; and a GPS (Global Positioning Satellite) system for reporting the location of the wearer to interested parties. A communication chip with an associated antenna, and an audio chip can also be included. Deviations in vital signs are used to detect health anomalies. In various embodiments, by aggregating data that is anonymously collected from multiple users, the system constructs models that are compared with data from a specific user, to warn the user before an emergency occurs, for certain classes of health incidents.

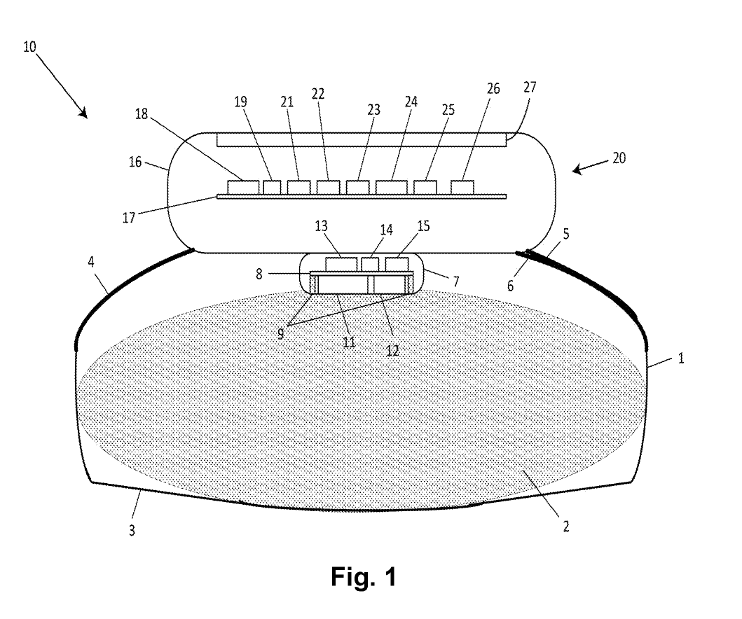

FIG. 1 is a cross-sectional view of an exemplary wrist mounted health monitoring system 10 in accordance with various embodiments of the present disclosure. A clasp or band 1 secures the device 10 to a user's wrist 2, and preferably employs a stiffening element 3 to provide a suitable force for pressing the device against the user's wrist 2. A cellular antenna 4 supports cellular communications. A Global Navigation Satellite System (GNSS) antenna 5 is also provided, used for communications with a Global Navigation Satellite System, a Global Positioning Satellite (GPS) system implemented in the United States, as well as in other nations. A diversity antenna 6 is additionally provided to augment the other antennas and improve their performance. A flex circuit (not shown) embedded in the clasp or band 1 may be used to connect the antennas to corresponding circuits on a second printed circuit board 17, to be described.

A sensor module 7 is shown within FIG. 1, with its bottom surface pressing against the user's skin; this module may be described as a skin tissue sensor. Module 7 includes, but is not limited to, a first printed circuit board 8, an array of conductive elements or capacitors 9 for confirming good contact with the user's wrist 2; an array of sensing circuits (not shown) associated with the array of conductive elements or capacitors for determining proper disposition of the skin tissue sensor relative to the user's body; light emitting diodes (LEDs) 11 having multiple operating frequencies; photo detectors 12 for measuring light originating from diodes 11 that subsequently diffuses through the user's blood and skin tissue; a temperature sensor 13 for recording ambient temperature and supporting calibration of sensor module 7; an accelerometer 14 for sensing falls and accidents, and for confirming user activity; and a first microprocessor 15 for controlling the sensor module 7. Light emitting diodes 11 preferably comprise a plurality of spaced-apart LEDs operating at multiple frequencies. Light emitting diodes 11 and photo detectors 12 are preferably arranged in a predetermined array format, such that absorption spectra may be measured. The absorption spectra may be used to determine vital signs of the user, and the vital signs may be used to make inferences about the user's health.

Within FIG. 1, an enclosure 16 surrounds a computer module 20 comprising, for example and without limitation, the following elements: a second printed circuit board 17; an embedded subscriber identification module (SIM) 18; cellular module 19 for supporting cellular communications; a second microprocessor 21 for controlling computer module 20, flash memory 22; SDRAM (synchronous dynamic random access memory) 23; battery and power management controller 24; charging interface 25 for charging a battery (not shown); a GNSS (Global Navigation Satellite System) module 26; and a touch/display screen 27. Computer module 20 preferably also comprises a voice chip (not shown), for signaling the user and potential local responders.

It is noted that the health monitoring system 10 may not include all of the elements illustrated by FIG. 1. In addition, the health monitoring system 10 can be implemented to include one or more elements not illustrated by FIG. 1. It is pointed out that the health monitoring system 10 can be utilized or implemented in any manner similar to that described and/or shown by the present disclosure, but is not limited to such.

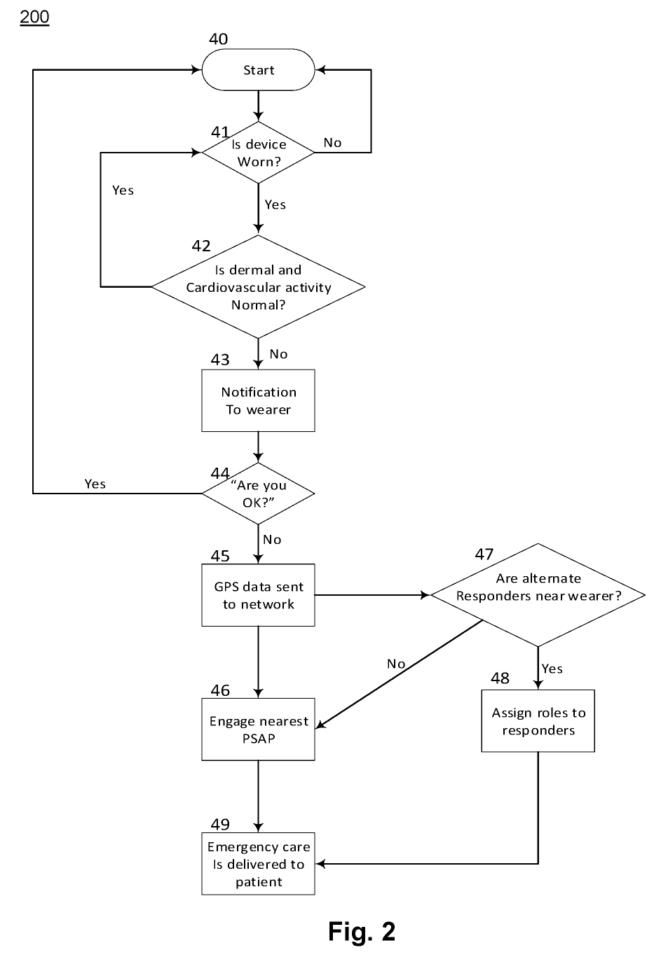

FIG. 2 is a flow chart of a method 200 representing a preferred embodiment in accordance with the present disclosure. Although specific operations are disclosed in FIG. 2, such operations are exemplary. The method 200 may not include all of the operations illustrated by FIG. 2. Also, method 200 may include various other operations and/or variations of the operations shown. Likewise, the sequence of the operations of flow diagram 200 can be modified. It is appreciated that not all of the operations in flow diagram 200 may be performed. In various embodiments, the operations of the flow chart 200 are executed by the second microprocessor 21, according to instructions contained in flash memory 22 or SDRAM 23. Start bubble 40 is entered at power on, or reset of health monitoring system 10. Decision block 41 determines if the device is properly seated against the user's wrist 2, taking advantage of bending forces generated in stiffening element 3. If not, the method 200 proceeds to start bubble 40. If the device is properly worn, system 10 operates sensor module 7 to determine if dermal and cardiovascular activity is normal; this condition may also be described as normal vital signs. Measurements involve using the sensor module to perform spatially resolved spectroscopy, which may be described as Near Infrared Spectroscopy (N IRS). Normal dermal activity may comprise tissue oxygenation measurements, or blood perfusion checking. Normal cardiovascular activity typically comprises heart rate monitoring and detection of anomalies such as fibrillation or unusual cardiac rhythms. Decision block 42 determines if the activity is normal or not.

If the activity measured in decision block 42 is normal, the method 200 proceeds to decision block 41. However, if the activity measured in decision block 42 is not normal, the wearer is notified in block 43. The process 200 flows to decision block 44 wherein the user is asked if he or she is okay. If the user responds in the positive, the method 200 proceeds to start bubble 40. However, if the user responds in the negative, location (GPS or GNSS) data is sent in block 45 to a support network, which typically includes a Public Safety Answering Point (PSAP). An example of a PSAP is a 911 call center, which will be engaged in block 46 by the encoded messages from health monitoring system 10. In addition, other medical resources may also be called upon, as in block 47. The other resources may include medical personnel such as doctors or nurses, or medical equipment such as defibrillators. If assistance is offered by a local responder, then health system 10 will coordinate the emergency response activities and assign roles to the local responders in block 48. If either the PSAP or local responders are available and engaged, emergency care will be delivered to the user as in block 49.

In a preferred embodiment in accordance with the present disclosure, health system 10 will be configurable to aggregate data from multiple users anonymously, and apply additional analysis to establish norms of behavior, and by comparing user data against the norms of behavior, predict some user health emergencies before they would otherwise occur. The additional analysis preferably includes machine learning.

In various embodiments, a skin-sensing wearable device checks if it being worn and how well it is seated on a person's skin. Bio-metric sensors such as optical sensors are sensitive to their proximity and orientation to the skin. Wearing a health monitoring device too tightly creates pressure on the skin, changes the skin tissue chemistry and invalidates medical diagnosis. If the optical sensors are not seated flush to the skin, light can reflect off the surface of the skin and contain no information related to blood flow or cardiovascular activity. The skin-sensing wearable device uses multiple skin-sensors of different types including capacitive-pad-sensors and conductive elements to determine skin proximity and pressure on the skin at different locations. The conductive elements may be called metal-contact-sensors in the rest of this description, but are not limited to such. The wearable device analyzes the measurements from the multiple skin-sensors to determine correct seating. Based on this analysis, the wearable device informs the wearer of issues, saves battery power and modifies the processing of the bio-metric sensor data.

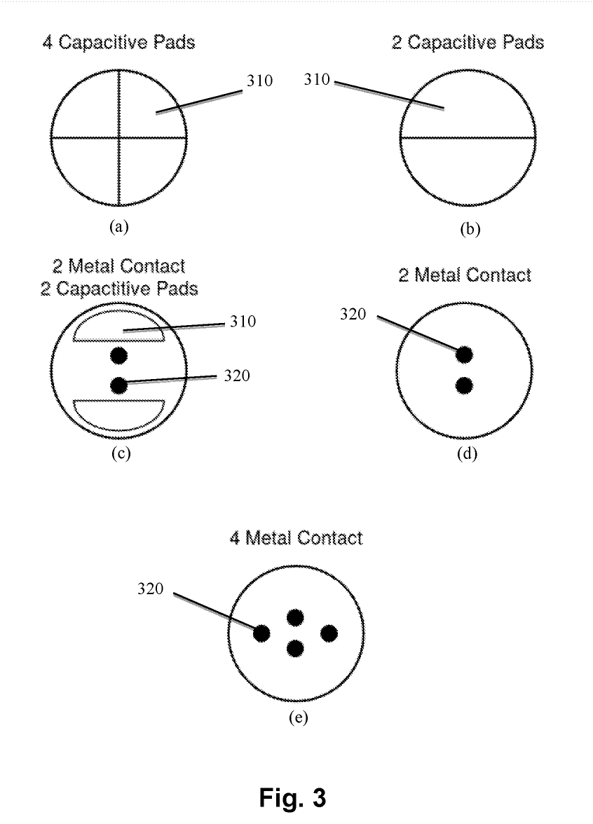

FIG. 3 shows example skin-sensor configurations in accordance with various embodiments of the present disclosure. For example, FIG. 3(a) shows four capacitive pads 310 arranged as four segments of a circle. A capacitive pad is created by coating an insulator with a conductive layer. The capacitive pads have an insulating layer between the pad and the exterior of the wearable device (e.g., 10), so the capacitive pad never touches the wearer's skin. In one embodiment, these are just bare pads directly placed on the PCB (e.g., 8), with the insulation being the plastic housing of the wearable device watch case. The capacitance of the capacitive pad varies with the proximity to the skin and the pressure on the skin. In one embodiment the capacitive pads are designed to be approximately 0.4 mm from the skin. The capacitive pads are connected (or coupled) to an electronic circuit creating a capacitive-pad-sensor. Having four capacitive-pad-sensors allows the wearable device to take four measurements allowing it to check for tilting in two perpendicular directions. FIG. 3(b) shows two capacitive pads 310 arranged as two segments of a circle. Two capacitive pads are usually easier to arrange on the wearable device (e.g., 10) and can be used when the incorrect seating is normally along one directional axis. FIG. 3(c) shows two capacitive pads 310 and two metal contacts 320. In one embodiment the metal contacts are gold plated. The metal contacts can be made from any conductive material but should not use metals that cause irritation from allergies, such as metals with high nickel content. In various embodiments, the metal contacts directly contact the skin and have a much higher signal to noise ratio but can involve more difficult mechanical and electrical considerations. For example, it is desirable for the metal contact circuit to have electrostatic discharge (ESD) protection since it is exposed to the world. The metal contacts 320 can be made from any conductive material that does not cause irritation. The metal contacts 320 are connected to an electronic circuit creating a metal-contact-sensor. The configuration of FIG. 3(c) provides multiple, different types of measurements which can be important when factors such as skin moisture content and hair influence the capacitive measurements. Moist skin creates a stronger signal (e.g., more capacitance), and hair makes it worse by creating small air gaps. FIG. 3(d) shows two metal contacts 320 arranged vertically. The configuration of FIG. 3(d) involves minimal surface area on the wearable device. FIG. 3(e) shows four metal contacts 320 arranged vertically and horizontal. The configuration of FIG. 3(d) allows measurements in two perpendicular directions and involves a relatively small surface area on the wearable device.

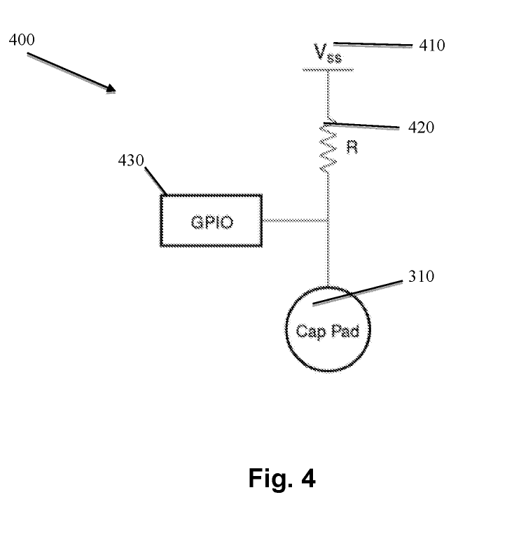

FIG. 4 shows an example capacitive-pad-sensor circuit implementation 400 in accordance with various embodiments of the present disclosure. The capacitive pad 310 is connected to the power supply (Vss) 410 through resistor 420. In this example, the general-purpose input/output (GPIO) capability 430 of a microprocessor or micro-controller-unit (MCU) 15 (FIG. 1) controls the capacitive pad 310. When the MCU 15 sets the GPIO 430 pin to ground (GND), the capacitive pad 310 discharges all the current quickly. When the MCU 15 allows the GPIO 430 pin to float, the capacitive pad 310 accumulates a charge. The MCU 15 measures the voltage of the GPIO 430 and uses the voltage rise time to estimate the capacitance and skin proximity. In one embodiment, a battery inside the wearable device (e.g., 10) provides a 1.8V (volts) power supply and the resistor has a resistance of 1 M Ohms (mega-ohms).

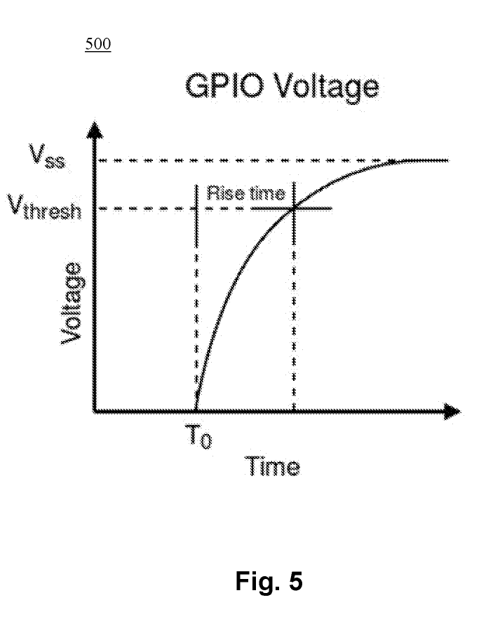

FIG. 5 shows a voltage-over-time graph 500 for a capacitive pad (e.g., 310) in accordance with various embodiments of the present disclosure. The voltage at the GPIO input rises to Vss with a time constant proportional to the resistance (R) times the capacitance of the capacitive pad. At time TO the MCU allows the GPIO pin to float. The voltage rise time is measured by a MCU timer beginning at TO and stopping when the GPIO voltage crosses a voltage threshold (Vthresh). The voltage rise time is typically measured in micro-seconds. In one embodiment the measurements are repeated and averaged to get more accuracy. In one example, an initial rise time of 100 micro-seconds indicates normal proximity and an initial rise time of 150 micro-seconds indicates touching the skin. The amount of charge the pad can store varies with the capacitance of the pad, which is affected by the proximity of skin.

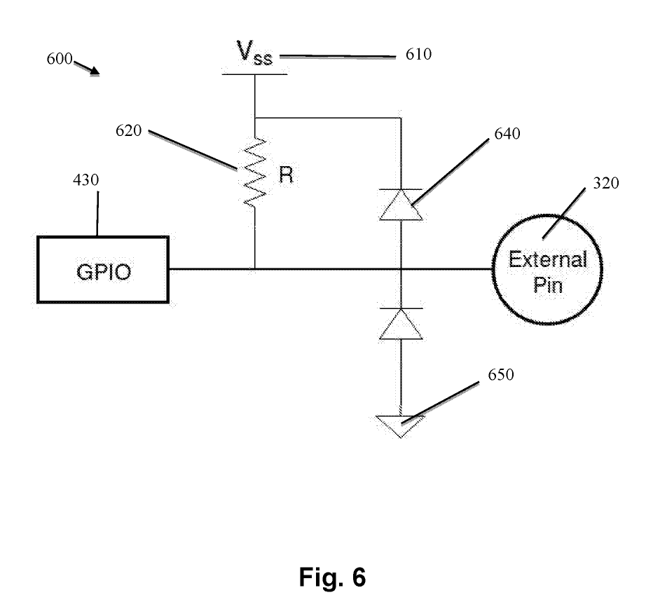

FIG. 6 shows an example metal-contact-sensor circuit implementation 600 in accordance with various embodiments of the present disclosure. The metal contact 320 is connected to the power supply (Vss) 610 through resistor 620. In this example, the general-purpose input/output (GPIO) capability 430 of a micro-controller-unit (MCU) controls the metal contact 320. When the MCU sets the GPIO pin to ground (GND) the metal contact 320 discharges all the current quickly. When the MCU allows the GPIO pin to float, the metal contact accumulates a charge. The MCU measures the voltage and uses the voltage rise time to estimate the capacitance and skin proximity. The metal-contact-sensor circuit uses ESD protection diodes 640 between the metal contact 320 and both Vss 610 and ground 650. The measurement is carried out in the same way as for a capacitive-pad-sensor, where the rise time changes with the amount of charge the pin will store. The amount of charge changes dramatically when in contact with skin.

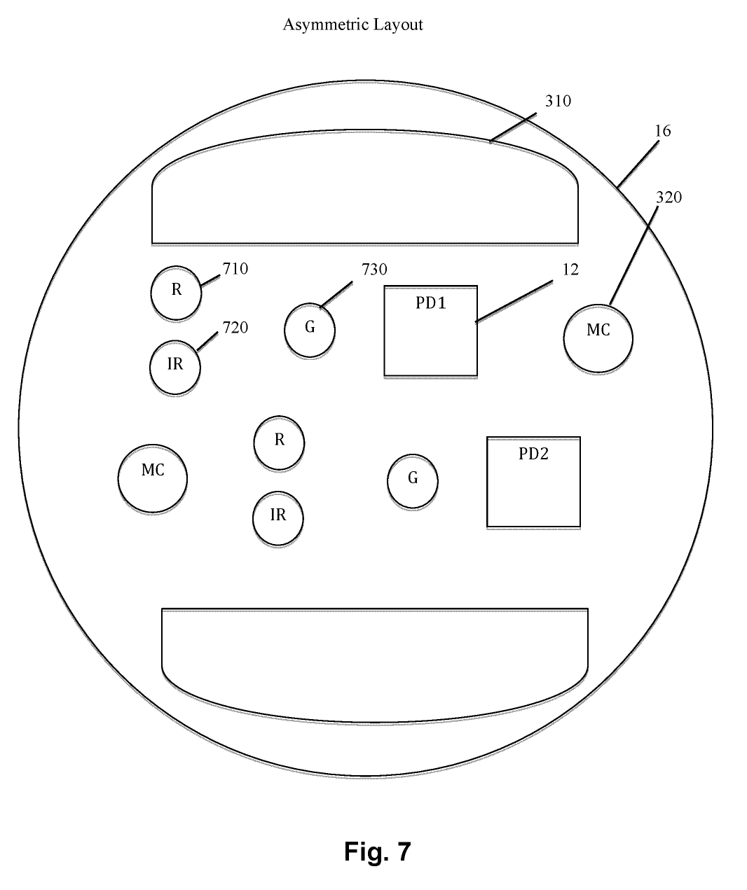

FIG. 7 shows an exemplary, asymmetric skin-sensing wearable device in accordance with various embodiments of the present disclosure. The skin-sensing wearable device enclosure 16 houses the skin-sensors 310 and 320; the LEDs 710, 720 and 730; and the optical sensors 12. In this example LED 710 transmits red light, LED 720 transmits infra-red light and LED 730 transmits green light. The optical sensors 12 are photo-diodes and sense the LED light. The magnitude of the various LED lights measured at the different photo-diodes 12 is used to detect oxygenation of the skin and detect medical issues. Ambient light interferes with photo-diode measurements and the photo-diode sensors 12 have ambient-light correction capabilities that helps them distinguish LED light from ambient light. If the wearable device is incorrectly seated, the ambient light may be sufficient to saturate the photo-diode and invalidate any measurements. Incorrect seating alters the angles between the LEDs and the photo-diodes 12 and this also affects the photo-diode measurements. Undue pressure from the wearable device onto the skin changes the skin tissue chemistry and interferes with the medical diagnosis. The skin-sensing wearable device uses both capacitive pads 310 and metal contacts 320 to check the seating of the skin-sensing wearable device on a person's wrist. In this example, the LED and optical sensor layout is asymmetric.

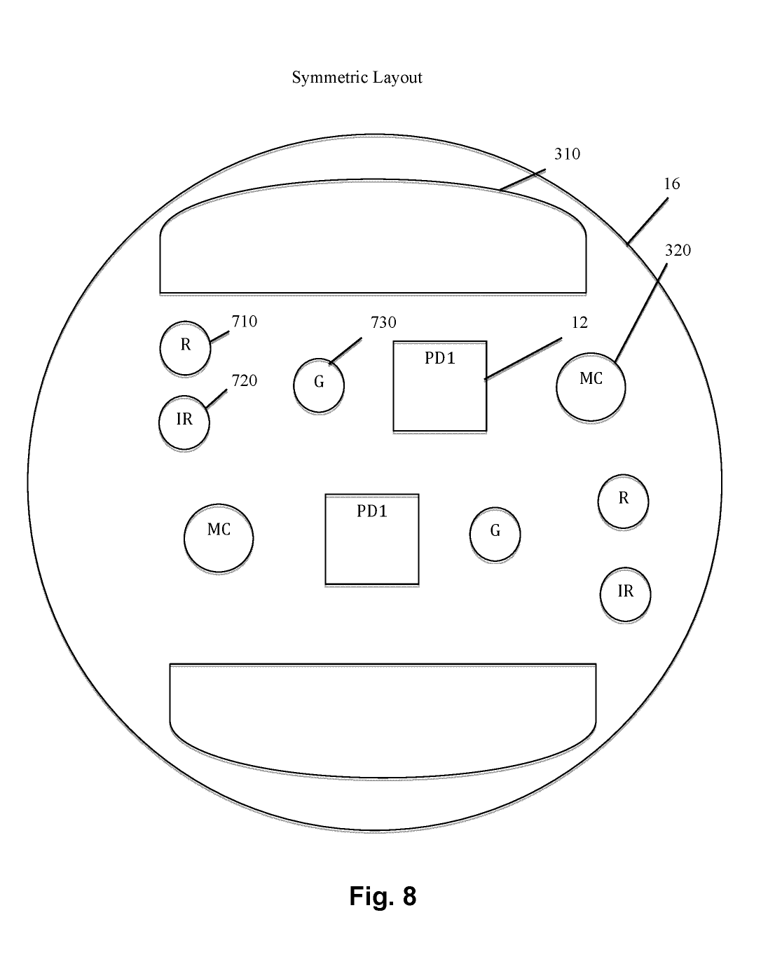

FIG. 8 shows an exemplary, symmetric skin-sensing wearable device in accordance with various embodiments of the present disclosure. FIG. 8 shows the same components as in FIG. 7 except that the LED and optical sensor layout is symmetric.

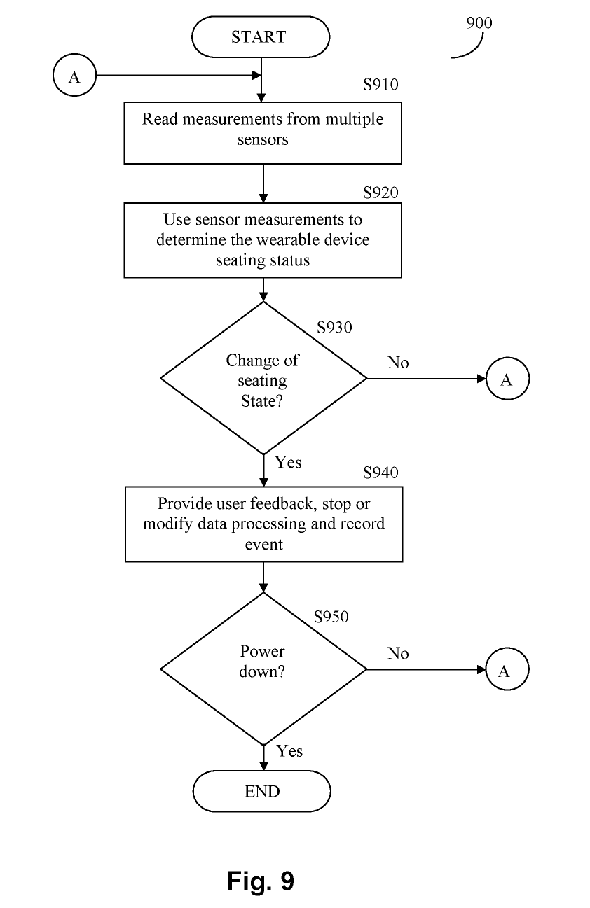

FIG. 9 shows an exemplary flowchart 900 for detecting and reacting to the skin-sensing measurements in accordance with various embodiments of the present disclosure. In one embodiment, the wearable device (e.g., 10) is controlled by the MCU (e.g., 15). The MCU executes software instructions that detect and react to the skin-sensing measurements. In various embodiments, the operations of the flowchart 900 are executed by the first microprocessor or MCU 15, according to instructions contained in flash memory 22 or SDRAM 23. In step S910 the wearable device (e.g., 10) reads measurements from both the skin-sensors and the optical-sensors (e.g., 12). The skin-sensors include any capacitive-pad-sensors (e.g., 310) and any metal-contact-sensors (e.g., 320). In various embodiments, the sole purpose of the skin-sensors is to check skin proximity and for correct device seating on the body. The primary purpose of the optical sensors is to detect medical issues but their measurements can also be used to check for correct device seating on the wrist or appropriate body part. In one embodiment, the skin-sensor measurements are taken twice every second, but is not limited to such. In various embodiments, the wearable device has the option to use a moving average of the skin-sensor measurements.

In step S920 the wearable device analyzes the sensor measurements and determines how well the wearable device is seated on the body. Prior to normal use the sensors are calibrated. A base-line measurement is taken for each sensor when the wearable device is not being worn. In one embodiment, the wearable device uses a second normal-baseline measurement for each sensor when the wearable device is correctly seated. This is the expected sensor measurement during normal operation. The sensor readings can be analyzed using a variety of methods. For example, in various embodiments, device tilting can be determined by comparing the measurements of two, partnered skin-sensors, located perpendicular to the tilt axis. In a first embodiment, each sensor measurement is compared to its partner sensor's measurement and if the difference is greater than a pre-defined threshold the wearable device concludes that the wearable device is incorrectly seated. For example, a wearable device may have two capacitive-pad-sensors (e.g., 310). Both provide measurements 100 units above the baseline when the wearable device is sitting correctly. When the wearable device is tilted up, one side will remain in good contact, and the other will lift off the skin and read a lower value. The first capacitive-pad-sensor still measures 100 units above the baseline, but the second capacitive-pad-sensor measures 60 units above baseline indicating it is not making as good of contact. In a second embodiment, each sensor measurement is compared to its normal-baseline measurement and if the difference is greater than a pre-defined threshold the wearable device concludes that the wearable device is incorrectly seated. In a third embodiment, the optical sensor measurements are considered. If the optical sensor measurements are normal (e.g., within a threshold) the wearable device considers the wearable device correctly seated regardless of the skin-sensor measurements. The wearable device determines if the wearable device is being worn by comparing the current sensor measurements to the not-being-worn baseline measurements. The wearable device also determines if the wearable device is causing undue pressure on the skin by analyzing sensor measurements.

In S930 of FIG. 9, the wearable device checks the wearable device seating status has changed in such a way as to require action. If the wearable device seating status is unchanged, the wearable device continues at step S910. If the wearable device seating status is changed, the wearable device continues at step S940. An obvious change of seating status is when the wearable device was correctly seated and has now become incorrectly seated. In one embodiment, a significant change of one or more skin-sensor measurements is counted as a status change even if the wearable device is still correctly seated.

In S940 the wearable device handles changes of state as follows:
a) If the wearable device seating has become incorrect, the wearable device warns the wearer and changes the bio-metric data processing to ignore the optical measurements. The wearable device informs the wearer with one or more the following actions: i) provide a textual message on the touch/display screen (e.g., 27); ii) provide an audible message; iii) provide an audible alarm; iv) produce a vibration to alert the wearer; v) show a picture that indicates how the device is incorrectly seated. Certain functions, such as bio-metric sensing, are turned off to reduce battery power use.
b) If the wearable device seating has become correct, the wearable device informs the wearer and changes the bio-metric data processing to process the optical measurements normally.
c) If the wearable device is no longer being worn, the wearable device warns the wearer and prepares to turn off the wearable device. If the wearer does not respond to the warning within a pre-specified amount of time the wearable device turns off the power to preserve battery power.
d) If the skin-sensor measurements change significantly while the device is correctly seated, the wearable device changes the bio-metric data processing to account for a slight device tilting or pressure change.
e) The wearable device maintains a history of the device being worn and incorrect seatings. This allows a doctor or care-giver to receive messages about and monitor wearable device use.

In S950 of FIG. 9, the wearable device determines if it is about to be powered off. If the wearable device is about to be powered off, the wearable device exits this method 900. If the wearable device is not about to be powered off, the wearable device continues at S910.

Although specific operations are disclosed in FIG. 9, such operations are examples. The method 900 may not include all of the operations illustrated by FIG. 9. Also, method 900 may include various other operations and/or variations of the operations shown. Likewise, the sequence of the operations of flow diagram 900 can be modified. It is appreciated that not all of the operations in flow diagram 900 may be performed.

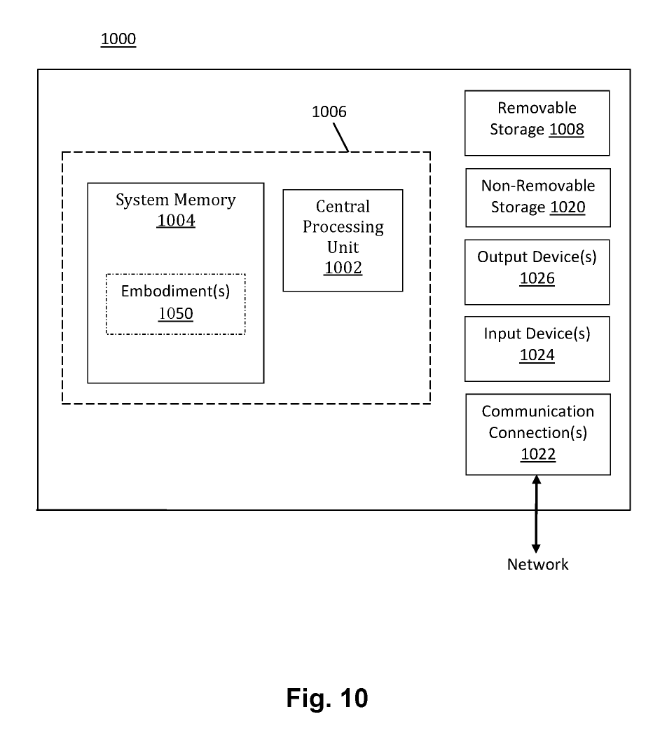

FIG. 10 shows a block diagram of an example of a computing system 1000 upon which one or more various embodiments described herein may be implemented in accordance with various embodiments of the present disclosure. In a basic configuration, the system 1000 includes at least one processing unit 1002 and memory 1004. This basic configuration is illustrated in FIG. 10 by dashed line 1006. The system 1000 may also have additional features and/or functionality. For example, the system 1000 may also include additional storage (e.g., removable and/or non-removable) including, but not limited to, magnetic or optical disks or tape. Such additional storage is illustrated in FIG. 10 by removable storage 1008 and non-removable storage 1020.

The system 1000 may also contain communications connection(s) 1022 that allow the device to communicate with other devices, e.g., in a networked environment using logical connections to one or more remote computers. Furthermore, the system 1000 may also include input device(s) 1024 such as, but not limited to, a voice input device, touch input device, keyboard, mouse, pen, touch input display device, etc. In addition, the system 1000 may also include output device(s) 1026 such as, but not limited to, a display device, speakers, printer, etc.

In the example of FIG. 10, the memory 1004 includes computer-readable instructions, data structures, program modules, and the like associated with one or more various embodiments 1050 in accordance with the present disclosure. However, the embodiment(s) 1052 may instead reside in any one of the computer storage media used by the system 1000, or may be distributed over some combination of the computer storage media, or may be distributed over some combination of networked computers, but is not limited to such.

It is noted that the computing system 1000 may not include all of the elements illustrated by FIG. 10. Moreover, the computing system 1000 can be implemented to include one or more elements not illustrated by FIG. 10. It is pointed out that the computing system 1000 can be utilized or implemented in any manner similar to that described and/or shown by the present disclosure, but is not limited to such.

All examples and conditional language recited herein are intended for pedagogical purposes to aid the reader in understanding the principles of the present disclosure and the concepts contributed by the inventor to furthering the art and are to be construed as being without limitation to such specifically recited examples and conditions. Moreover, all statements herein reciting principles, aspects, and embodiments of the present disclosure, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

The foregoing descriptions of various specific embodiments in accordance with the present disclosure have been presented for purposes of illustration and description. They are not intended to be exhaustive or to limit the present disclosure to the precise forms disclosed, and many modifications and variations are possible in light of the above teaching. The present disclosure is to be construed according to the Claims and their equivalents.

What is claimed is:

1. A wearable device comprising:
a processor;
a memory containing instructions to be executed by the processor; and
a plurality of sensors,
wherein the processor is operable to utilize measurements from the plurality of sensors to check seating status of the wearable device on skin of a wearer of the wearable device.

2. The wearable device as described in claim 1, wherein the plurality of sensors comprise a capacitive pad.

3. The wearable device as described in claim 1, wherein the plurality of sensors comprise a conductive element.

4. The wearable device as described in claim 1, wherein the plurality of sensors comprise an optical sensor.

5. The wearable device as described in claim 1, wherein the wearable device is operable to inform the wearer that the seating status is incorrect comprises using at least one of: display a message, produce an audible message, produce an audible alarm, produce a vibration, and display a picture.

6. The wearable device as described in claim 1, wherein the wearable device is operable to maintain a history of seating status of the wearable device and allows review of the history.

7. The wearable device as described in claim 1, wherein the wearable device is operable to adjust its bio-metric data processing based on the seating status.

8. The wearable device as described in claim 1, wherein the wearable device is operable to turn off bio-metric sensing based on the seating status.

9. A method for detecting seating of a wearable device, the method comprising:
reading measurements from a plurality of sensors with a processor of the wearable device; and
analyzing the measurements with the processor to check seating status of the wearable device on skin of a wearer of the wearable device.

10. The method as described in claim 9, wherein the plurality of sensors comprise a capacitive pad.

11. The method as described in claim 9, wherein the plurality of sensors comprise a conductive element.

12. The method as described in claim 9, wherein the plurality of sensors comprise an optical sensor.

13. The method as described in claim 9, further comprising:
informing the wearer that the seating status is incorrect comprises the wearable device performing at least one of: displaying a message, producing an audible message, producing an audible alarm, producing a vibration, and displaying a picture.

14. The method as described in claim 9, further comprising:
maintaining a history of seating status with the processor.

15. The method as described in claim 9, further comprising:
adjusting bio-metric data processing based on the seating status with the processor.

16. A wearable device comprising:
a processor;
a memory containing instructions to be executed by the processor;
a plurality of capacitive pad sensors;
a plurality of conductive sensors; and
a plurality of optical sensors;
wherein the processor is operable to utilize measurements from the plurality of capacitive pad sensors, the plurality of conductive sensors, and the plurality of optical sensors to check seating status of the wearable device on skin of a wearer of the wearable device.

17. The wearable device as described in claim 16, wherein the wearable device is operable to inform the wearer that the seating status is incorrect comprises at least one of: display a message, produce an audible message, produce an audible alarm, produce a vibration, and display a picture.

18. The wearable device as described in claim 16, wherein the wearable device is operable to maintain a history of seating status of the wearable device and allows review of the history.

19. The wearable device as described in claim 16, wherein the wearable device is operable to adjust its bio-metric data processing based on the seating status.

20. The wearable device as described in claim 16, wherein the wearable device is operable to turn off bio-metric sensing based on the seating status.
